(19) United States
(12) Patent Application Publication
(10) Pub. No.: US 2006/0002334 A1
(43) Pub. Date: Jan. 5, 2006

(54) WiFi network communication security system and method

(76) Inventor: E. Russell Washburn III, Roebuck, SC (US)

Correspondence Address: Tony D. Alexander;TECHNOLOGY LEGAL COUNSEL LLC, Post Office Box 1728, Evans, GA, 30809, US

(21) Appl. No.: 11/157,592

(22) Filed: Jun. 21, 2005

Related U.S. Application Data
(60) Provisional application No. 60/581,507, filed on Jun. 21, 2004.

(51) Int. Cl. H04Q 7/00

(52) U.S. Cl. 370/328

(57) ABSTRACT

In an exemplary embodiment in accordance with the present invention, a system and method is provided that ensures users of public domain wide area networks in particular and networks generally, secure, authenticated and dynamic access to the network. Specifically, the present invention in preferred embodiments provides secure, authenticated and dynamic access to networks, through hotspots, in the WiFi Spectrum by employing microprocessing chipsets having the capabilities of a wireless provisioning device.

### FIELD OF THE INVENTION

The present invention relates generally to network security and more particularly to a system and a method of providing ARP tactic resistant security for WIFI networks in particular.

### BACKGROUND OF THE INVENTION

Wireless Fidelity (WiFi), otherwise known as Wireless Networking, commonly uses the 802.11b protocol. The principal advantages of WiFi are numerous. Principally, the overall cost of updating data communications networks will decrease because of lower capital equipment expenditures. WiFi greatly simplifies the planning and maintenance process since capability can easily be added or moved by moving or adding a node. WiFi allows employees to remotely access the corporate network without reliance on a dedicated dial-up number or a VPN, but instead use the Internet to access their corporate applications with ubiquitous public hotspots.

WiFi will also have an impact on VoIP. While voice over the LAN has been possible for some time, its benefits were generally considered marginal when compared to cost of implementation including special equipment requirements and additional LAN capacity. VoIP has already shown great promise and is gradually replacing the traditional PBXs as that gear is fully amortized. The case for VoIP, however, becomes even stronger with WiFi. The marriage of data and voice in a WLAN environment, with the full-feature capabilities of the IP PBX, is certain to be the wave of the future.

Conversely, WiFi has limitations related to its signal strength and data packet processing methods. Because of the queue and sequence process associated with WiFi, it is possible for a legitimate device to flood the system with data requests. Moreover, research indicates that, in about an hour, any skilled user with basic WiFi equipment could determine the encryption key for a corporate WiFi network by intercepting and analyzing scrambled data passing over the network from a nearby parking lot.

Unlike lower frequencies that have a diminished data rate, WiFi has a greater data rate. Unfortunately, the tradeoff is less penetration efficiency and loss of control over the access points for a particular network. This loss of network access control has frightened many network administrators, especially considering the poor security reputation of WiFi.

Controlled frequencies such as TDMA and CDMA allow users to amplify the source signal significantly higher than the WiFi spectrum as well as limit unwanted congestion in the spectrum, which enables even greater ranges despite limited signal strength on client devices.

Therefore, there remains a need for a system and method of providing the advantages of WiFi in networks generally and VoIP systems in particular while alleviating the shortcomings of WiFi. In particular, there is a need for a WiFi network that provides a robust authentication and access control.

### SUMMARY OF EXEMPLARY EMBODIMENTS

In an exemplary embodiment in accordance with the present invention, a system and method is provided that ensures users of public domain wide area networks in particular and networks generally, secure, authenticated and dynamic access to the network. Specifically, the present invention in preferred embodiments provides secure, authenticated and dynamic access to networks, through hotspots, in the WiFi Spectrum.

The “Man In The Middle” attack is a well-known attack methodology where an attacker sniffs packets from the network, modifies them and inserts them back into the network. ARP spoofing involves forging a packet source hardware address (MAC address) to the address of the host you pretend to be. Session Hijacking involves an attacker using captured, brute forced, or reverse-engineered authentication tokens to seize control of a legitimate user's web application session while that user is logged into the application. This usually results in the legitimate user losing access or functionality to the current web session, while the attacker is able to perform all normal application functions with the same privileges of the legitimate user. This class of attacks usually relies on a combination of other simpler Session Management attacks.

Both “Man In The Middle” and Session Hijacking attacks utilize ARP. In order to prevent these and other attacks and render ARP secure, the present inventor conceived a method that in a preferred embodiment comprises a proprietary client that disables ARP when the IP Stack comes up in the operating system. In the furtherance of this and other objectives, all ARP packets would subsequently be rejected. Moreover, this client side application makes UDP packet request looking for a Kerberos key from the server to establish static ARP on route controller and the user's PC, while allowing client DHCP requests without ARP entries on the route controller. As a result, all data must travel from user's PC to the route controller, which makes auditing and IDS more robust due to the fact that all data is evaluated by the RTC. The device is also capable of supporting inter-translation between UDP to TCP such that the device is able to recognize and capture emergency information and redirect that information to the proper authorities. This may be accomplished through the route controller to a telephone, which is preferably VoIP enabled.

A bad packet list is created and the route controller only lets packets through that are not on the list. The IDS system detects source, destination and modus operandi (i.e., signature) of the hack. Individually benign data may be allowed through but as a coordinated group of data's score increases to a predefined score parameter during a predefined period of time, subsequent access is blocked. This differs from conventional systems in that the audit function is not localized allowing the every data packet to be screened at the same location.

A principal objective of a preferred embodiment of the present invention is to provide an easy to use authenticated system. In the furtherance of this and other objectives, the username and password do not have to be retyped into the SSL layer every time a session is initiated, rather they can be saved into the client. Additionally, an IP table entry is made on the RTC to make the route effective and allow entry.

An additional objective in accordance with the present invention is to provide an enhanced audit function. A preferred audit system tracks all data packets and puts them into a relational database, which stores only unique entries. A report is subsequently generated that provides a DNS resolution of all of the material accessed. DNS Fails messages are generally an indication of unwanted data on the system (e.g., outbound zombies). Unlike spam filters that focus on the spam data itself, the present method filters spam by limiting IP addresses allowed on the system; essentially the system blocks the serves that send the spam. However, in the instant application, SIP DNS is accomplished to support the dynamic payload type necessary for such an application.

There is an additional objective in accordance with the present invention, which provides a method of optimizing bandwidth by limiting spam source server access to the system. Statistically, a quarter of any network's data traffic is unwanted data. By blocking the server that originates the spam rather than the individual data packets, the system traffic is significantly reduced. This principally follows from the fact that packet-by-packet analysis and its concomitant bandwidth overhead allocation is not required once a server has been identified as a source of undesirable data.

Yet another objective in accordance with the present invention is to provide a routing system that allows a SQL database to report upward to an intelligent router, which can propagate downward to the other routers to shut down the entire system or segmentally. Threat level scores can also give indications of perceived weaknesses in the system so they can be rectified and render the system less desirable of a target.

Further objectives, features and advantages of the invention will be apparent from the following detailed description taken in conjunction with the accompanying drawings.

### DETAILED DESCRIPTION OF THE PREFERRED EMBODIMENTS

IEEE 802.11 is a standard for wireless systems that operate in the 2.4-2.5 GHz ISM (industrial, scientific and medical) band. This ISM band is available worldwide and allows unlicensed operation for spread spectrum systems. For both the US and Europe, the 2,400-2,483.5 MHz bond has been allocated, while for some other countries, such as Japan, another part of the 2.4-2.5 GHz ISM band has been assigned. The 802.11 standard focuses on the MAC (medium access control) protocol and PHY (physical layer) protocol for access point (AP) based networks and ad-hoc networks. WiFi generally refers to the 802.11b standard.

In access point based networks, the stations within a group or cell can communicate only directly to the access point. This access point forwards messages to the destination station within the same cell or through a wired distribution system to another access point, from which such messages arrive finally at the destination station. In ad-hoc networks, the stations operate on a peer-to-peer level and there is no access point or (wired) distribution system.

The 802.11 standard supports: DSSS (direct sequence spread spectrum) with differential encoded BPSK and QPSK; FHSS (frequency hopping spread spectrum) with GFSK (Gaussian FSK); and infrared with PPM (pulse position modulation). These three physical layer protocols (DSSS, FHSS and infrared) all provide bit rates of 2 and 1 Mbit/s. The 802.11 standard further includes extensions 11a and 11b. Extension 11b is for a high rate CCK (Complementary Code Keying) physical layer protocol, providing bit rates 11 and 5.5 Mbit/s as well as the basic DSSS bit rates of 2 and 1 Mbit/s within the same 2.4-2.5 GHz ISM band. Extension 11a is for a high bit rate OFDM (Orthogonal Frequency Division Multiplexing) physical layer protocol standard providing bit rates in the range of 6 to 54 Mbit/s in the 5 GHz band.

The 802.11 basic medium access behavior allows interoperability between compatible physical layer protocols through the use of the CSMA/CA (carrier sense multiple access with a collision avoidance) protocol and a random back-off time following a busy medium condition. In addition all directed traffic uses immediate positive acknowledgement (ACK frame), where a retransmission is scheduled by the sender if no positive acknowledgement is received. The 802.11 CSMA/CA protocol is designed to reduce the collision probability between multiple stations accessing the medium at the point in time where collisions are most likely occur. The highest probability of a collision occurs just after the medium becomes free, following a busy medium. This is because multiple stations would have been waiting for the medium to become available again. Therefore, a random back-off arrangement is used to resolve medium contention conflicts. In addition, the 802.11 MAC defines: special functional behavior for fragmentation of packets; medium reservation via RTS/CTS (request-to-send/clear-to-send) polling interaction; and point co-ordination (for time-bounded services).

The IEEE 802.11 MAC also defines Beacon frames, sent at a regular interval by an AP to allow wireless stations (STAs) to monitor the presence of the AP. IEEE 802.11 also defines a set of management frames including Probe Request frames which are sent by an STA, and are followed by Probe Response frames sent by the AP. Probe Request frames allow an STA to actively scan whether there is an AP operating on a certain channel frequency, and for the AP to show to the STA what parameter settings this AP is using.

IEEE 802.11 is a shared, wireless local area network (LAN) standard. It uses the carrier sense multiple access (CSMA), medium access control (MAC) protocol with collision avoidance (CA). This standard allows for both direct sequence (DS), and frequency-hopping (FH) spread spectrum transmissions at the physical layer. The maximum data rate initially offered by this standard was 2 megabits per second. A higher-speed version, with a physical layer definition under the IEEE 802.11b specification, allows a data rate of up to 11 megabits per second using DS spread spectrum transmission. The IEEE standards committee has also defined physical layer criteria under the IEEE 802.11a specification. This is based on orthogonal frequency-division multiplexing (OFDM) that will permit data transfer rates up to 54 megabits per second.

While IEEE 802.11 has experienced a rapid growth in the wireless local area network LAN environment, a number of security concerns have been raised for wireless networks in general. The IEEE 802.11 wireless LAN standard defines authentication and encryption services based on the Wired Equivalent Privacy (WEP) algorithm. The WEP algorithm defines the use of a 40-bit secret key for authentication and encryption. Many IEEE 802.11 implementations also allow 104-bit secret keys. However, the standard does not define a key management protocol, and presumes that the secret, shared keys are delivered to the IEEE 802.11 wireless station via a secure channel independent of IEEE 802.11.

The lack of a WEP key management protocol is a principal limitation to providing IEEE 802.11 security; especially in a wireless infrastructure network mode with a large number of stations. The lack of authentication and encryption services also effects operation in a wireless, ad hoc network mode where users may wish to engage in peer-to-peer collaborative communication; for example, in areas such as conference rooms.

As a result, the enhanced importance of authentication and encryption, in a wireless environment, proves the need for access control and security mechanisms that include the key management protocol specified in IEEE 802.11.

It has been shown that routing wired networks at connection nodes has long stood as the most efficient and secure means of passing Internet data. However, this method uses upgrades to old voice networks. The wired solution will never be useful for providing service to the mobile user. However, to date wireless Internet Access has been sought but security, limitation of service and mobile IP stand in the way of this solution for mobile broadband.

The WPDWAN has evolved the following features that address these concerns. The first aspect of the WPDWAN is contained in the mobile Authentication method. Using the Lightweight Directory Access Protocol (LDAP) authentication schema, a user of the present system and method is able to control the network in a manner not traditionally considered for a data network.

The LDAP device contains user profiles. That directory is broken into sections by user type such as customer and employee. These types have sub groups such as location where service is initiated and where the individual is allowed to obtain access on the network. This tree also allows for the control of bandwidth and can even be defined to the time of day that the allotted bandwidth can be distributed.

The LDAP server works in conjunction with a DHCP server that has been modified for the purpose of this network. Connection to the radio network is a complex matter that does not in itself provide network connectivity. The LDAP server tests the connection to the radio network for the Manufacture Access Code (MAC) address. This number is transmitted in each data pack and is compared to the value stored in the user profile. If the two match the DHCP server authorizes an IP address for delivery to the user connecting.

This method of authentication at this point is rather simple to penetrate. By guessing the address block served by the DHCP server the user can guess an address on the block and enter into the network. However, the present inventor made one other modification to the network in that all traffic on the local node for the wireless must pass through a route controller computer. This box has a limited number of active routes. These routes are established and removed by the DHCP software. When a lease is activated the route is created. If the lease expires the route is removed. Certain tests are run throughout the process to determine if the customer has discontinued use of the lease before the expiration of the lease. In this case the route is also removed after the lease is determined vacant for 5 minutes. The vacancy time takes into consideration the transit between cells to insure the client ample time to travel between connection points without disruption of the socket layer.

The LDAP feature provides two significant differences to the RADIUS method implement through CHAP or PPPOE. The first significant change prevents the authentication method from violating an effect of the 802.11b protocol. The LDAP route controller method allows the user to transit from tower to tower without interruption at the socket layer. This means seamless transitions between towers will result. The socket layer connection maintenance insures the user can maintain connections for streaming video and audio as well as SMTP traffic.

Scalability is also a feature an exemplary embodiment of the present invention. The LDAP standard provides for a distributed replication method of data. As the user set grows more and more requests will be made for authentication. Because the LDAP solution natively supports distributed replication, the user information can be loaded into a machine local to his border point to the Internet cloud. This information will propagate to the master LDAP server and then be propagated throughout the network. However, when requests for authentication occur on a fully operational network the request for authentication will only be made at the border point. This reduces overall network traffic to the Internet cloud and increases throughput to the user. This also reduces computer capacity in local areas by distributing the load to the replica machines at each Macro cell. This reduces cost of the system. In the case that one component of the network fails, the replication feature allows other components to pick up the failure and solve the problem until a repair can be made. This eliminates single point failures of authentication.

The next essential component of an exemplary WPDWAN is the customer premise equipment, namely the wireless provisioning device. It is a router with a wireless interface. A preferred embodiment of the wireless provisioning device is provided in co-pending U.S. patent application Ser. No. 09/660,709, which is incorporated herein by this reference. The wireless provisioning device can control bandwidth speed and data type as well as provide firewall capability.

In a preferred embodiment this device is also capable of supporting inter-translation between UDP to TCP such that the device is able to recognize and capture emergency information and redirect that information to the proper authorities. This may be accomplished through the route controller to a telephone, which is preferably VoIP enabled. In the furtherance of this objective, by way of example only, a user of a mobile device at a hotspot may place a consumer VoIP emergency call which may be located and re-directed by the present route controller to the PSTN through a telephone line at the hotspot location.

One aspect of the wireless provisioning router is to provide routing at each node connection point. This aspect provides for a stronger network and provides flexibility in network design. This feature allows for better network traffic management improving the overall bandwidth by reducing network latency through the optimization of routes and data packet management. Although the wireless provisioning device is capable of bridging it will be the determination of the network engineer to establish the wireless provisioning device as a bridge to the network or a router to the network. This feature gives the network engineer more flexibility to the network design. Furthermore the flexible nature of the equipment allows the user to change a leaf node that bridges into a major backbone node that routes through the use of code modification without the need to reboot. Subsequently as a node begins to grow the network engineer can upgrade that node to fit the needs of the network without banning existing customers. By inserting the cards in the slots of a chassis that contains at least one operating system (OS), preferably open source LINUX as its operating system, the wireless provisioning device can be configured as a router or a bridge. It should be noted that throughout the specification, reference to operating systems may reference only one generally and LINUX in particular. This in no way should limit the invention to UNIX based operating systems generally or LINUX in particular. Operating systems useful in the present invention may include but are not limited to DOS, UNIX, LINUX, Windows, MacOS, 2K, Aegis, Fox, BDX Express, FluxOS, HOPE YOctix, UniqueOS, XOS, NachOS, Xinu, ConiX, JavaOS, PalmOS, etc. There may be multiple different operating systems on one chipset, or alternatively on a multiple chipset within a single chassis. The routing model of LINUX is not a portion of the main operating kernel. Being a sub component of the OS, the routing module can be upgraded and modified without rebooting the system. A reboot of an advanced LINUX box may take up to 30 minutes to complete. The upgrade of a routing module in LINUX takes less than 2 seconds to reinitialize. This re-initialization is transparent to the customers attached to this box. The routing module is replaceable by abridging module if routing is not a necessity for the connection node. Routing at the connection point allows for filtering of IP addresses for either all the customers attached to that node or for an individual IP address attached to that node. Furthermore the routing module contains routing logic capable of bandwidth shaping. This process only allows certain volumes of data to be transmitted to and/or from a certain customer IP address. Because of the LDAP structure this bandwidth allotment is controlled through the profile of the user as established on the LDAP server.

The second feature of the WPDWAN revolves around the addition of more access points. Through the use of wireless provisioning device integration to the system a flexible configuration is introduced. The wireless provisioning device may contain up to 7 wireless connections and 1 wired connection, or 7 wired connections and 1 wireless connection or any combination as seen fit for the network or alternative be configured with a microprocessor chipset that allows for an indeterminate number of connections while allowing for the miniaturization of the provisioning device. This reduces overall cost and decreases space requirements. By placing this system on a faster chip set the equipment effectively processes more data from the same point. Furthermore this feature allows the expansion of the system to develop from an outlying leaf node with little usage to a major backbone node with multiple redundancy without affecting existing customers. The user can also increase the number of potential customers to the connection point in the network by adding cards and antennas without the need for chassis changes. Because the physical configuration of the system resides in a chassis of a microcomputer, the wireless provisioning device can be configured with differing numbers of wireless cards and network cards. The chassis may contain a multiplicity of processors. In preferred embodiments, the device and/or system runs on a UNIX based system but may employ alternative operating systems that may be satisfactory for hefty data management. This processor configuration and extensive amounts of RAM memory allows the operating system to handle extensively more information than the traditional wireless connection points.

The increased functionality of the wireless provisioning device also modifies the IP assignment of the WPDWAN. As a third feature of the WPDW AN, DHCP is used to assign all mobile users, and most static users of the service. Static IP's may also be added for large static customers when IP allocation is a requirement. Because DHCP is a second layer protocol, routed networks cannot pass DHCP assignment through a router. However, the WPDWAN design incorporates the wireless provisioning device design as either a bridge or router. When acting as a bridge or switch the DHCP allocation passes through the wireless provisioning device to the customer machine seamlessly. However, when the wireless provisioning device is acting as a router the DHCP assignment must come from the wireless provisioning device itself. To logically segment the network in such a fashion as to provide each wireless provisioning device with an IP block is cumbersome. Since the routers can all slave to master BGP routers, advanced tables may be created on the BGP routers or other servers to provide dynamic segmentation to the wireless provisioning device. Therefore, segments can be created that optimized IP addressing as users enter and exit the network.

The WPDWAN centers on the security of the wireless network. Each wireless provisioning device is capable of running an ISO-4 standard encryption package capable of creating a VPN to a VPN host located at the border router. This solution prevents traffic from being intercepted while in the wireless network.

Further securing the wireless provisioning device is the method of hiding the wireless provisioning device through the route controller. All connections on the client side of the wireless provisioning device are provided routes to the wireless provisioning device, however routes to both interfaces of the wireless provisioning device are removed from the route controller. The wireless provisioning device can only be accessed when one or both of these routes are added to the route controller box. Using a secure shell telnet connection to the wireless provisioning device, message traffic and administrative information cannot be sniffed by public domain users on the network. Due to this feature WPDWAN can be made available. This feature uses a more universal management schema of telnet. The WPDWAN is administrated using secure shell telnet integrated with an HTML browser script written in, for example, PERL. Connection to all management nodes is limited to authorized IP addresses, reducing the chances of unauthorized network entries. Present day wireless equipment utilizes the SNMP V -1 protocol for the management of the connection device. SNMP V-I is limited to clear text message traffic. Any connection made to this connection point is on the same logical segment as those that are doing administrative work to the connection device. In every network solution logical segments contain all the information that is passed within that segment. Sniffing traffic on that logical segment has long been known to be a problem within networking. SNMP V -6 protocol is the typical solution to this problem while using SNMP protocol. However, SNMP V -6 is a processor intense protocol providing for extensive network overhead. By using a secure telnet connection the network overhead is reduced while increasing the security of the system. A secure telnet connection only allows certain IP's to connect to certain data ports. This limited connection structure effectively creates different logical segments within the same physical network segment. The newly created logical segment prevents the sniffing of administrative traffic by the common user. Furthermore the shell connection is managed by an HTML based GUI. To date virtually all WPDWAN have the connection points managed by proprietary Windows™ based GUIs. These GUIs allow for the management of one Node at a time. The WPDWAN GUI can manage several nodes at any given time. The user can sort through several diagnostic processes to insure problems are limited to certain areas and not pervasive throughout the network. This method of management is more intuitive and more complete previously developed WPDWAN.

The WPDWAN is capable of removing limited static MAC addressing and the inclusion of RADIUS authentication. The RADIUS authentication is tied to the MAC addressing in conjunction with a username and password. This method of authentication greatly reduces the chances of service theft and allows the user a mobile solution between cells assuming the resolution of mobile IP. Furthermore this feature lends itself to a directory services method that allows a more customized interface for the user. Using IP filtering, authorization levels and enterprise user management the WPDWAN with directory service has the ability to control bandwidth consumption, and provide a more custom service to the user. Without RADIUS authentication users connect to the network without any control from a central server. By providing RADIUS one server controls the abilities of the user to enter certain parts of the network.

The WPDWAN allows connections from both single PC cards and from other wireless provisioning devices. Through the use of this feature the same WPDWAN may contain single users and large LANs. In present day wireless WANs, the user must choose to provide service to either PC's containing the cards or to a wireless connection bridge. Commercial users would then select to use a wireless connection bridge while a residential user may choose to use a PC. Without the wireless provisioning device, multiple WPDWANs have to be erected to satisfy all types of customers. The WPDWANs incorporation of the wireless provisioning device allows the user to connect to the wireless infrastructure using either an individual PC on the Internet Cloud or another WPDWAN connection point as authorized by the connection point device. In this case one WPDWAN may be erected while satisfying all potential customer types.

The WPDWAN has the ability to deal with mobile IP. By removing the BGP routing component one layer from all the wireless routers, users are able to float between multiple out-point connections. Since the BGP is broadcast to all other BGP routers in the WPDW AN, all users may move from point to point while the routers broadcast handoffs and modify traffic flow. In other WPDWAN the user will be limited to one outflow period, unless the user reboots the machine. The BGP handoff is valid for DHCP served IP addresses or static IPs provided the IP address has been entered into the BGP table.

The WPDWAN also utilizes 2.4 Ghz unlicensed spread spectrum wireless equipment. Large scale routed WANs to date have been developed using either wired technology or some licensed frequency. In both cases the infrastructure costs have been extremely high for both the network owner and the end user. The wired WANs have not been able to provide any mobile ability. The licensed frequencies are extremely expensive and very limited in design. Furthermore efforts in these spectrums have not advanced the bandwidth transmissions to the rates we have developed.

Specific reference is made to U.S. patent application Ser. Nos. 09/660,709, 10/223,255, 60/496,088 and 60/539,242 filed Sep. 13, 2000, Aug. 15, 2002 and Aug. 18, 2002 and Jan. 26, 2004 respectively, which are incorporated, in their entirety, herein by this reference.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

What is claimed is:

1. A method of providing secure, authenticated, mobile client access to a WiFi Spectrum network, without resort to a client side driver, comprising the steps of:
receiving from a client a start session message containing user identity information, the start session message being received by the route controller using the communications network in accordance with a client control protocol, the start session message being sent automatically upon the client being logged on to the service provider independent of the client controller; and
sending to the client a control message to control the client's access to use the communications network, the control message being sent from the route controller using the communications network in accordance with the client control protocol and in response to the start session message.

2. The method of claim 1, further comprising the step of routing a message to a telephone, via the route controller, when a specified code is located on the client device when the start session message is sent thereby.

3. The method of claim 2, wherein the telephone is a VoIP enabled telephone.

4. A route controller to control a client's access to use a wireless wide area communications network, the route controller comprising:
a communications port capable of receiving from the client a start session message containing user identity information, the start session message being received by the client controller using the communications network in accordance with a client control protocol, the start session message being sent automatically upon the client being logged on to the service provider independent of the client controller;
a user database containing information associated with the user identity information; and
a client control processor coupled to said communications port and said user database, said client control processor being configured to send a control message to the client to control the client's access to use the communications network, the control message being sent from the client controller using the communications network in accordance with the client control protocol and in response to the start session message;
wherein the control message control message is a session authorization message that determine whether the client is granted or denied access to use the communications network for a predetermined period of time.

5. The client controller of claim 4, wherein the route controller is housed in a chassis.

6. The client controller of claim 4, wherein the route controller is housed on a single chip.

7. An apparatus for providing secure, authenticated, mobile wireless client access to use a WiFi spectrum network, comprising:
means for receiving from the client a start session message containing user identity information, the start session message being received by the client controller using the communications network in accordance with a client control protocol, the start session message being sent automatically upon the client being logged on to the service provider independent of the client controller;
means for determining if the client is authorized to access the communications network; and
means for sending to the client a session authorization message, the session authorization message to control the client's access to use the communications network being sent from the client controller using the communications network in accordance with the client control protocol and in response to the start session message.

8. The apparatus of claim 7, wherein the apparatus is housed within a chassis.

9. The apparatus of claim 8, wherein the route controller is capable of routing a message to a telephone, in response to a specified code resident on the client device when the start session message is sent thereby.

10. The apparatus of claim 7, wherein the apparatus further comprises at least one operating system selected from the group consisting of DOS, UNIX, LINUX, Windows, MacOS, 2K, Aegis, Fox, BDX Express, FluxOS, HOPE YOctix, UniqueOS, XOS, NachOS, Xinu, ConiX, JavaOS, PalmOS and combinations thereof.

11. The apparatus of claim 10, wherein the apparatus is housed within a chassis.

12. The apparatus of claim 10, wherein the apparatus resides on at least one chip.

13. An article of manufacture comprising a computer-readable medium having stored thereon instructions adapted to be executed by a processor, the instructions which, when executed, define a series of steps to control a client's access to use a secure, authenticated, WiFi spectrum network, said steps comprising:
receiving from the client a start session message containing user identity information, the start session message being received by the client controller using the communications network in accordance with a client control protocol, the start session message being sent automatically upon the client being logged on to the service provider independent of the client controller; and
sending to the client a control message to control the client's access to use the communications network, the control message being sent from the client controller using the communications network in accordance with the client control protocol and in response to the start session message, wherein the control message control message is a session authorization message that determine whether the client is granted or denied access to use the communications network for a predetermined period of time.

14. A method of using a communications network having a route controller, comprising the steps of:
accessing the route controller though a service provider independent of the client controller;
sending to the route controller a start session message containing user identity information, the start session message being sent automatically upon being logged on to the service provide; and
receiving from the route controller a control message to control whether the client is authorized or denied access to use the communications network, the control message being received by the client using the communications network in accordance with a client control protocol and in response to the start session message, wherein the control message control message is a session authorization message that determine whether the client is granted or denied access to use the communications network for a predetermined period of time.

15. The method of claim 14, further comprising the step of routing a message to a telephone, via the route controller, when a specified code is located on the client device when the start session message is sent thereby.

16. The method of claim 15, wherein the telephone is VoIP enabled telephone.

17. An article of manufacture comprising a computer-readable medium having stored thereon instructions adapted to be executed by a processor, the instructions which, when executed, define a series of steps to use a communications network having a route controller, said steps comprising:
accessing the route controller through a wireless communication entry point;
sending to the route controller a start session message containing user identity information; and
receiving from the route controller a control message to control whether the client is authorized or denied access to use the communications network, the control message being received by the client using the communications network in accordance with a client control protocol and in response to the start session message.

18. The apparatus of claim 17, wherein the apparatus is housed within a chassis.

19. The apparatus of claim 18, wherein the route controller is capable of routing a message to a telephone, in response to a specified code resident on the client device when the start session message is sent thereby.

20. The apparatus of claim 17, wherein the apparatus further comprises at least one operating system selected from the group consisting of DOS, UNIX, LINUX, Windows, MacOS, 2K, Aegis, Fox, BDX Express, FluxOS, HOPE YOctix, UniqueOS, XOS, NachOS, Xinu, ConiX, JavaOS, PalmOS and combinations thereof.
